(19) United States
(12) Patent Application Publication
(10) Pub. No.: US 2008/0298187 A1
(43) Pub. Date: Dec. 4, 2008

(54) OPTICAL DISC DEVICE AND RECORDING POWER CONTROL METHOD

(75) Inventor: Yasuhiro WADA, Kawaguchi-shi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi-LG Data Storage, Inc.

(21) Appl. No.: 12/129,730

(22) Filed: May 30, 2008

(30) Foreign Application Priority Data
May 30, 2007 (JP) 2007-143636

(51) Int. Cl. G11B 7/12

(52) U.S. Cl. 369/47.5

(57) ABSTRACT

An optical disc device and recording power control method that can ensure the recording quality of data recorded on an optical disc are suggested. When recording data on an optical disc, data recorded on the optical disc is reproduced periodically; a β value, an index of recording quality of the data on the optical disc, is obtained based on a waveform of the reproduced data; a correction factor of recording power is calculated based on the obtained β value, and the recording power is corrected according to the correction factor; at the same time, a recording area of the optical disc is divided into a plurality of zones and the correction factor for each zone is managed; and the recording power is corrected according to the correction factor of the zone where data is to be recorded next on the optical disc.

### CROSS-REFERENCES TO RELATED APPLICATIONS

This application relates to and claims priority from Japanese Patent Application No. 2007-143636, filed on May 30, 2007, the entire disclosure of which is incorporated herein by reference.

### BACKGROUND

1. Field of the Invention

The present invention relates to an optical disc device and a recording power control method and is ideal for use in an optical disc device compatible with, for example, Blu-ray Discs (BD).

2. Description of Related Art

Conventionally, recording power adjustment processing called “OPC (Optimum Power Calibration)” is executed on an optical disc device when recording data on an optical disc. The OPC involves performing test writing of predefined data in a test write area provided in the innermost circumferential area of the optical disc and then determining optimum recording power (hereinafter simply referred to as the “optimum recording power”) based on a waveform of the reproduced test-written data.

However, since the OPC is executed before starting to record data, it cannot respond to any change in the optimum recording power that occurs with an environmental change or a change of a recording position on the optical disc after starting to record the data. Therefore, a method called “walking OPC” has been recently suggested as a recording power control method to deal with changes in the optimum recording power (see Japanese Patent Application Laid-Open (Kokai) Publications No. 2004-234812, 2003-331426, and 2005-92950).

The walking OPC method involves stopping recording at regular space or time intervals, reproducing a record end portion, evaluating the recording quality of data at the record end portion, and correcting the recording power based on the evaluation result. Recording power control using this walking OPC method has been widely utilized in recent years because it can realize high recording quality that ensures reproduction compatibility with different optical disc devices.

In the walking OPC method, a parameter called a “β value” indicating amplitude asymmetry is used as an index of recording quality. Using the walking OPC method, a correction factor for recording power is calculated at regular space or time intervals based on a previously-set β value that is a target value (hereinafter referred to as the “target β value” as necessary) and a β value obtained by reproducing the relevant record end portion (hereinafter referred to as the “measured β value” as necessary); and the recording power is then corrected based on the obtained correction factor.

The β value changes almost uniformly according to changes in the recording power. Therefore, when using the β value as an index of recording quality not only in the case of recording methods like a CLV (Constant Linear Velocity) method where the recording power is always constant, but also in the case of recording methods like a CAV (Constant Angular Velocity) method where the recording speed accelerates toward the outer circumference of an optical disc and the recording power increases accordingly, the relationship between the difference between the target β value and the measured β value, and the correction amount for the recording power can be uniform.

However, the change ratio of the β value to the recording power differs from one optical disc to the next depending on optical disc type. As a result, an optical disc device that employs the walking OPC method retains target β values for different kinds of optical discs and is configured to use a corresponding target β value corresponding to the optical disc mounted on the optical disc device at that time.

Regarding a DVD (Digital Versatile Disc) for example, data is recorded sequentially from its inner circumference toward its outer circumference. Consequently, an optical disc device compatible with DVDs stores only one correction factor for the recording power for the walking OPC and uses this correction factor by sequentially updating it to the then-obtained latest correction factor every time the walking OPC is executed.

However, a Blu-ray Disc has recording areas called “spare areas” along its inner and outer circumferences as alternate areas to be used for recording user data when there is a defect in a user data area. Therefore, the Blu-ray Disc may record data by changing a recording position, for example, from the user data area to the inner-circumference-side spare area or from the user data area to the outer-circumference-side spare area.

In that case, the disc sensitivity or similar of a Blu-ray Disc may not be always uniform over the entire recording surface. Therefore, when the conventional walking OPC method described above is adopted with a Blu-ray Disc, if the correction factor obtained at a distant position on the same optical disc is used to correct the recording power, the recording of data with the optimum recording power may not be realized. In such cases, there is a possibility that the recording quality might deteriorate.

### SUMMARY

The present invention was devised in light of the circumstances described above. The invention aims to suggest an optical disc device and recording power control method that can ensure the recording quality of data recorded on an optical disc.

In order to achieve the above-described object according to an aspect of the invention, provided is an optical disc device including: a reproduction unit for periodically reproducing data recorded on an optical disc when recording that data on the optical disc; a correction factor calculator for obtaining a β value, an index of recording quality of the data on the optical disc, based on a waveform of the data reproduced by the reproduction unit, and calculating a correction factor of recording power based on the obtained β value; a correction factor management unit for dividing a recording area of the optical disc into a plurality of zones and managing the correction factor for each of the zones; and a recording power corrector for correcting the recording power according to the correction factor for the zone where data is to be recorded next on the optical disc.

According to another aspect of the invention, provided is a recording power control method including: a first step of periodically reproducing data recorded on an optical disc when recording data on the optical disc; a second step of obtaining a β value, an index of recording quality of the data on the optical disc, based on a waveform of the reproduced data, and calculating a correction factor of recording power based on the obtained β value; and a third step of correcting the recording power according to the correction factor; wherein a recording area of the optical disc is divided into a plurality of zones and the correction factor is managed for each of the zones; and wherein in the third step, the recording power is corrected according to the correction factor for the zone where data is to be recorded next on the optical disc.

This invention can always record data with optimum recording power even when the optical disc device records data while changing the recording position on the optical disc. Therefore, the recording quality of data recorded on the optical disc can be ensured.

Other aspects and advantages of the invention will be apparent from the following description and the appended claims.

### BRIEF DESCRIPTION OF THE DRAWINGS

FIG. 1 is a block diagram showing the configuration of an optical disc device according to an embodiment of the present invention.

FIGS. 2A and 2B are graphs for explaining a recording power control method for the optical disc device according to the embodiment.

FIG. 3 is a conceptual diagram illustrating virtual zones.

FIG. 4 is a conceptual diagram illustrating a virtual zone start address management table.

FIG. 5 is a conceptual diagram illustrating a correction factor management table.

FIG. 6 is a conceptual diagram illustrating a storage table.

FIG. 7 is a flowchart illustrating a recording processing sequence.

FIG. 8 is a flowchart illustrating a recording processing sequence.

### DETAILED DESCRIPTION OF PREFERRED EMBODIMENTS

An embodiment of the present invention will be described below in detail with reference to the attached drawings.

### (1) Configuration of Optical Disc Device According to this Embodiment

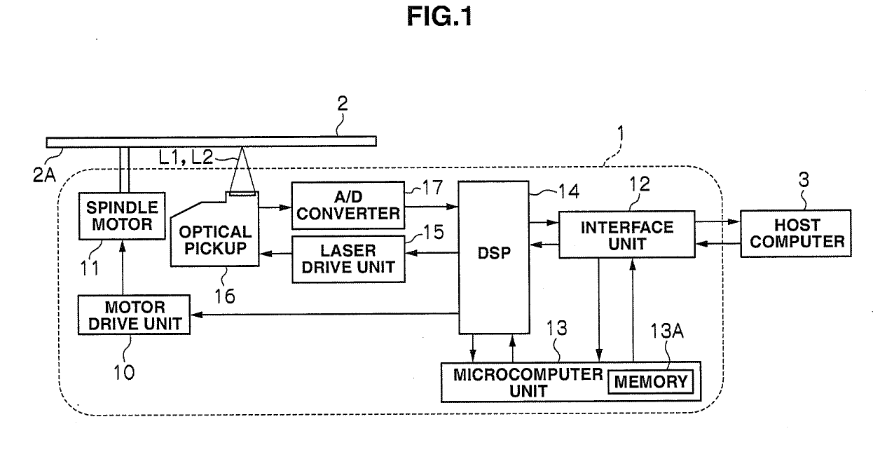

FIG. 1 shows an optical disc device 1 according to an embodiment of the present invention. This optical disc device 1 is compatible with an optical disc 2, including not only Blu-ray Discs, but also DVDs. This optical disc device 1 can, in response to a request from a host computer 3, record data on the optical disc 2 or reproduce data recorded on the optical disc 2.

Specifically speaking, with this optical disc device 1, a motor drive unit 10 drives a spindle motor 11 under the control of a microcomputer unit 13, thereby rotating the optical disc 2, which is mounted as specified, according to a recording method for the optical disc 2 (such as the CAV method or the CLV method).

Also, with the optical disc device 1, various commands sent from the host computer 3 are supplied via an interface unit 12 to the microcomputer unit 13.

The microcomputer unit 13 includes memory 13A that stores, for example, control programs and various control data. The microcomputer unit 13 executes necessary control processing and arithmetic processing according to commands from the host computer 3 and various information from a digital signal processor 14.

After receiving a recording command from the host computer 3, the microcomputer unit 13 controls the interface unit 12 to have the target data to be recorded which will be then received from the host computer 3, be sent to the digital signal processor 14.

The digital signal processor 14 executes predetermined signal processing, including modulation processing, on the target data (to be recorded) received via the interface unit 13, and then sends the obtained record signal as a driving signal to a laser drive unit 15.

The laser drive unit 15 activates a laser diode (not shown in the drawing) in an optical pickup 16 and causes it to blink according to the driving signal supplied from the digital signal processor 14. As a result, a laser beam L1 that is space-modulated based on the driving signal (recording signal) is emitted from the laser diode, and this laser beam L1 is focused via a focus lens (not shown in the drawing) in the optical pickup 16 onto a recording surface 2A of the optical disc 2. Consequently, the target data is recorded onto the optical disc 2.

Light L2 of the laser beam L1 reflected from the optical disc 2 undergoes photoelectric conversion by a photodetector (not shown in the drawing) in the optical pickup 16. Subsequently, an RF (Radio Frequency) signal obtained as a result of this photoelectric conversion undergoes digital conversion by an analogue-digital converter 17, and the obtained digital RF signal is supplied to the digital signal processor 14.

The digital signal processor 14 generates, based on the supplied digital RF signal, various kinds of control signals such as a focus error signal, a tracking error signal, and a rotation control signal. Consequently, a biaxial actuator (not shown in the drawing) in the optical pickup 16 is controlled based on the focus error signal and the tracking error signal, thereby performing focus control and tracking control. Also, the rotation control signal is supplied to the motor drive unit 10, which then performs rotation control of the spindle motor 11 based on the rotation control signal.

Part of the laser beam L1 emitted from the laser diode in the optical pickup 16 undergoes photoelectric conversion by an APC (Auto Power Control) photodetector (not shown in the drawing in the optical pickup 16. Subsequently, an RF signal obtained as a result of this photoelectric conversion undergoes digital conversion by the analogue-digital converter 17, and the obtained digital RF signal is then supplied to the digital signal processor 14.

Consequently, the digital signal processor 14 controls, based on the digital RF signal, the signal level of the driving signal to be sent to the laser drive unit 15 so that the recording power will become previously-set target recording power (hereinafter referred to as the “target recording power”) (APC control).

On the other hand, after receiving a reproduction command from the host computer 3 via the interface unit 12, the microcomputer unit 13 controls the digital signal processor 14 to have it send a specified control signal to the laser drive unit 15.

The laser drive unit 15 activates the laser diode in the optical pickup 16, and keeps it on, at specified voltage according to the supplied control signal. As a result, this laser diode emits a laser beam with specified power, and this laser beam is focused via the aforementioned focus lens onto the recording surface 2A of the optical disc 2.

The light L2 of the laser beam L1 reflected from the optical disc 2 undergoes photoelectric conversion by the photodetector in the optical pickup 16. Subsequently, the RF signal obtained as a result of this photoelectric conversion undergoes digital conversion by the analogue-digital converter 17, and the obtained digital RF signal is supplied to the digital signal processor 14.

The digital signal processor 14 executes reproduction signal processing, such as demodulation processing, on the supplied digital RF signal, and then sends the obtained reproduction data via the interface unit 12 to the host computer 3.

When this happens, the digital signal processor 14 generates various kinds of control signals such as a focus error signal, a tracking error signal, and a rotation control signal based on the supplied digital RF signal in the same manner as when recording data. As a result, the focus control, the tracking control, and the rotation control of the spindle motor 11 are performed based on the focus error signal, the tracking error signal, and the rotation control signal in the same manner as when recording data.

### (2) Recording Power Control Method for this Optical Disc Device

A recording power control method utilized in the above-described optical disc device 1 will be explained below.

In the case of the optical disc device 1 according to this embodiment, there are two operation modes for recording data (hereinafter referred as “recording mode(s)”): a walking OPC mode, in which data is recorded sequentially while executing the aforementioned walking OPC; and a verify mode, in which whether data is recorded properly or not is verified by reproducing the recorded data from the optical disc 2 and comparing it with target data to be recorded every time a specified amount of clusters (for example, 30 clusters) of data is recorded. If proper data recording fails in the verify mode, that data is then recorded in the spare area.

Regarding a recording power control method for the optical disc device 1, the walking OPC method is utilized in the walking OPC mode, while a recording power control method similar to the walking OPC method is utilized in the verify mode by measuring the β value every time the recorded data is reproduced.

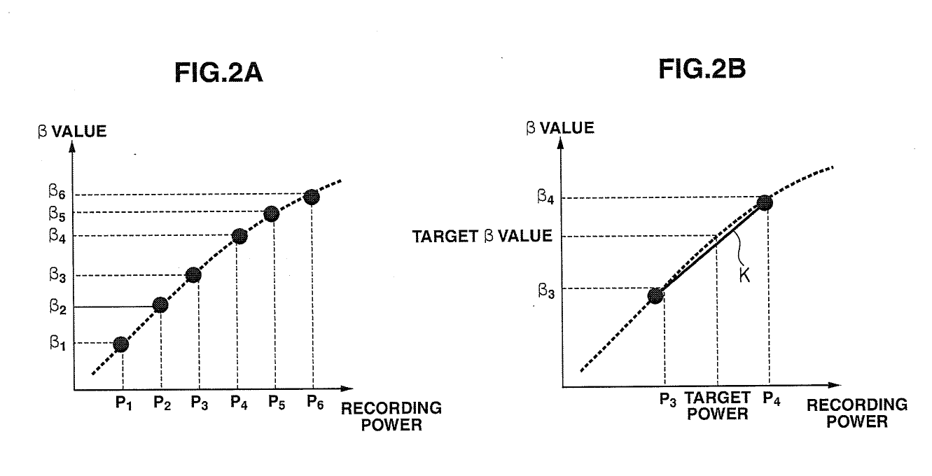

Since the recording power is controlled while obtaining the measured β value using the walking OPC method (and the recording power control method in the verify mode), it is possible to detect a relationship between the recording power at that time (P₁, P₂, and so on) and the measured β value (β₁, β₂, and so on) based on some of the measured β values (β₁, β₂, and so on) obtained in the middle of data recording as shown in FIG. 2(A). Specifically speaking, it is possible to find the change ratio of the measured β value to the recording power at that time, i.e., the slope of line segment K in FIG. 2(B).

The optical disc device 1 calculates change ratio A of the measured β value to the recording power (the slope of line segment K in FIG. 2(B)) based on the relationship between the measured β value and the recording power at that time as obtained by the recording power control. The optical disc device 1 also calculates a correction factor R_{UP} of the recording power using the following formula using the inverse number of the change ratio A (1/A) as a correction coefficient:

### Formula 1

Rᵤₚ=R_{up′}+(target β value−measured β value)×1/A (1)

The optical disc device 1 then calculates new APC control target recording power after the correction by adding “1” to the calculated correction factor R_{UP} and then multiplying the obtained number by the current APC control target recording power. Incidentally, “R_{UP′}” in formula (1) indicates the correction factor calculated last time (if it is the first time, “R_{UP′}” is the initial value).

The correction factor R_{UP} according to this embodiment is the increase/decrease rate of the recording power immediately after correction by the OPC when starting to record data (hereinafter referred to as the “reference recording power”). If the correction coefficient (1/A) obtained by evaluating the recording quality for the first time is “1” and the difference between the target β value and the measured p value (the target β value−the measured β value) is “1,” the correction factor R_{UP} will be “1[%].” As a result, in this case, the recording power obtained by increasing the reference recording power by 1[%] is the APC control target recording power until the recording quality is evaluated next time.

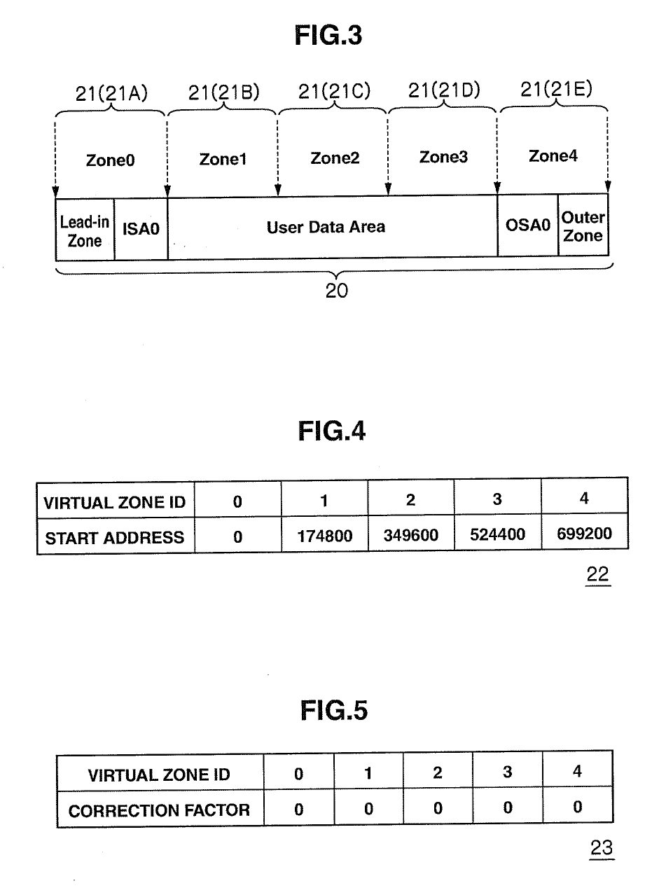

With the optical disc device 1, a recording area 20 of the optical disc 2 is divided into a plurality of virtual zones (hereinafter referred to as “virtual zones”) 21 (21A to 21E) as shown in FIG. 3, and the correction factor R_{UP} described above is obtained and stored for each virtual zone 21. When recording data on the optical disc 2, the correction factor R_{UP} for the virtual zone 21 where that data is to be recorded is used to correct the APC control target recording power.

Incidentally, FIG. 3 shows an example in which a lead-in zone (“Lead-in Zone”) storing management information such as a maker code for the relevant optical disc and an inner-circumference-side spare area (“ISAO”) are set as one virtual zone 21 (“Zone 0”); three virtual zones 21 (“Zone 1” to “Zone 3”) are set for a user data area (“User Data Area”); and an outer-circumference-side spare area (“OSAO”) and an outer zone storing management information similar to the lead-in zone (“Outer Zone”) are set as one virtual zone 21 (“Zone 4”).

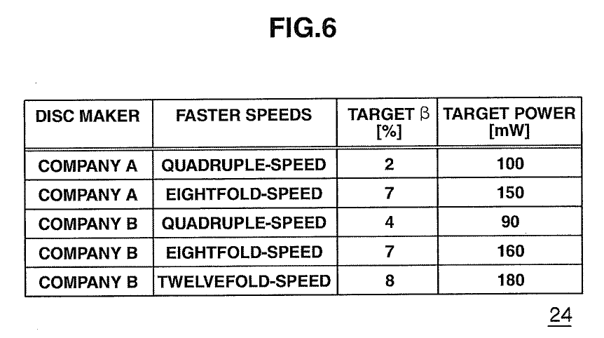

As a means of controlling the recording power for each virtual zone 21, the optical disc device 1 stores in the memory 13A for the microcomputer unit 13: a virtual zone start address management table 22 shown in FIG. 4, a correction factor management table 23 shown in FIG. 5, and a storage table 24 shown in FIG. 6.

The virtual zone start address management table 22 is a table for managing the start address of each virtual zone 21, and stores the start address of each virtual zone 21 in association with an ID assigned to the relevant virtual zone 21 (hereinafter referred to as the “virtual zone ID”).

This virtual zone start address management table 22 is created by the microcomputer unit 13 when the optical disc 2 is mounted on the optical disc device 1. Specifically speaking, when the optical disc 2 is mounted on the optical disc device 1, the microcomputer unit 13 divides the recording area 20 of the relevant optical disc 2 (FIG. 3) into a predetermined number (for example, five) of virtual zones 21, associates the start address of each virtual zone 21 with a virtual zone ID for the relevant virtual zone 21, and stores the associated start addresses and virtual zone IDs in the virtual zone start address management table 22.

The correction factor management table 23 is a table for managing the correction factor R_{UP} for each virtual zone 21, and stores the correction factor R_{UP} for each virtual zone 21 in association with the virtual zone ID for the relevant virtual zone 21. Incidentally, at the initial stage where no data is recorded on the relevant optical disc 2, “0” is stored as an initial value for the correction factor R_{UP} for each virtual zone 21.

The storage table 24 is a table storing a target β value and target recording power for each optical disc 2 sold by each maker regarding each recording speed such as normal speed, double speed, and quadruple-speed.

When the optical disc 2 is mounted in the optical disc device 1, the optical disc device 1 reads the maker name of the optical disc 2 stored in the lead-in zone or the outer zone, and also reads the maker name of the relevant optical disc 2 and the target β value corresponding to the relevant recording speed from among the respective target β values stored in the storage table 24, and uses them for computation of formula (1).

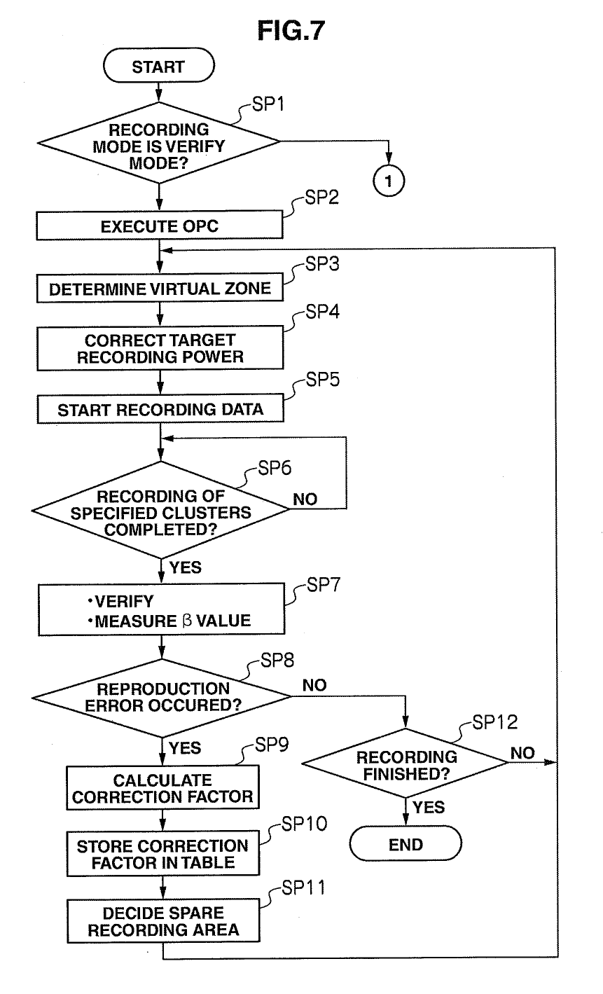

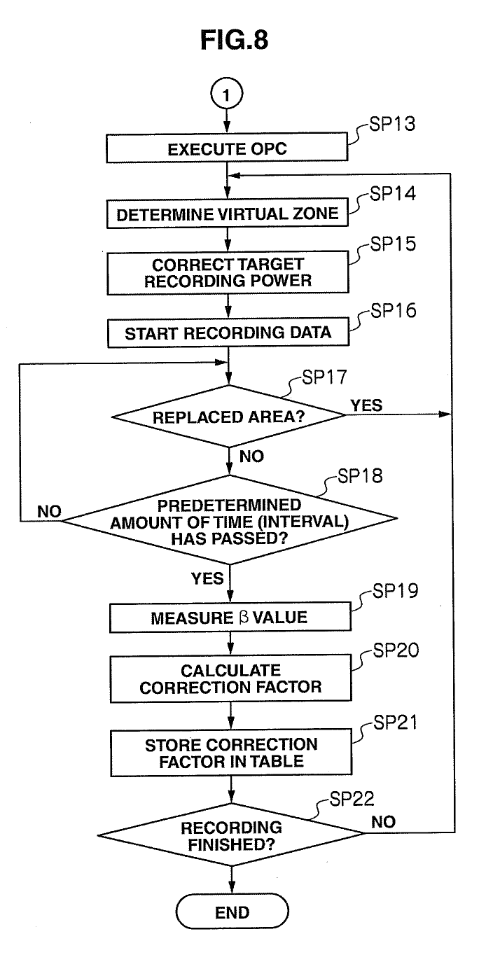

In the case of the optical disc device 1 according to this embodiment, the recording power control of each virtual zone 21 is executed under the control of the microcomputer unit 13 in accordance with the control programs stored in the memory 13A for the microcomputer unit 13 according to a processing sequence as shown in FIGS. 7 and 8.

Specifically speaking, after receiving a recording command from the host computer 3, the microcomputer unit 13 starts the recording processing illustrated in FIGS. 7 and 8, and first judges whether the recording mode designated by the recording command is the verify mode or not (SP1).

If step SP1 returns an affirmative judgment, the microcomputer unit 13 controls the digital signal processor 14 and a seek motor (not shown in the drawing) to perform test writing to a PCA of the optical disc 2 and measure a value at that time. Based on the measured β value obtained, the microcomputer unit 13 corrects the APC control target recording power which is set in the digital signal processor 14 (SP2). Incidentally, the β value measuring method and target recording power correction method will be explained later (see SP4 and SP7).

Subsequently, the microcomputer unit 13, based on the address of a data recording start position included in the recording command and on the virtual zone start address management table 22 (FIG. 4), judges which virtual zone 21 the data recording start position on the optical disc 2 belongs to (SP3).

According to the judgment result in step SP3, the microcomputer unit 13 reads the correction factor R_{UP} for the virtual zone 21 to which the data recording start position (or a start position of an area where data is to be recorded next) stored in the correction factor management table 23 (FIG. 5) belongs. The microcomputer unit 13 also multiplies this correction factor R_{UP} by the current APC control target recording power and then sets the multiplication result as post-correction, new APC control target recording power to the digital signal processor 14 (SP4).

Furthermore, the microcomputer unit 13 controls the seek motor to move the optical pickup 16 to the recording start position and also drives the digital signal processor 14 to start recording data with the target recording power set in step SP4 (SP5).

After starting to record the data, the microcomputer unit 13 waits for the completion of the recording of a predetermined number of clusters (for example, 30 clusters) of data (SP6).

If step SP6 returns an affirmative judgment after the data recording was started and when recording the predetermined number of clusters of data is completed, the microcomputer unit 13 verifies the data recorded on the optical disc 2 and, at the same time, measures the β value at that time (SP7).

Specifically speaking, the microcomputer unit 13 controls the digital signal processor 14 and the seek motor, etc., to stop recording data on the optical disc 2 and reproduce the predetermined clusters of data then recorded on the optical disc 2. Also, the then-obtained RF signal is supplied as a digital RF signal via the analogue-digital converter 17 to the digital signal processor 14.

The digital signal processor 14 executes predetermined signal processing, such as demodulation processing, on the supplied digital RF signal and then judges whether or not the thus-obtained reproduced data is identical to the data retained in the internal memory (not shown in the drawing) and recorded on the optical disc 2 at that time. Then, the digital signal processor 14 outputs this judgment result (whether identical or not identical) to the microcomputer unit 13.

The digital signal processor 14 calculates, based on the reproduction signal obtained during the above-described signal processing, the β value at that time (the measured β value) by the following formula:

### Formula 2

β=(a1+a2)/(a1−a2) (2)

Incidentally, in this formula (2), “a1” represents the maximum level for the reproduction signal and “a2” represents the minimum level for the reproduction signal. The digital signal processor 14 sends the thus-obtained β value to the microcomputer unit 13.

On the other hand, the microcomputer unit 13 judges, based on the aforementioned judgment result given by the digital signal processor 14, whether a reproduction error occurred or not (SP8). Specifically speaking, if the judgment result indicates that the data is “not identical,” the microcomputer unit 13 determines that a reproduction error occurred; or if the judgment result indicates that the data is “identical,” the microcomputer unit 13 determines that no reproduction error occurred.

If an affirmative judgment is returned in the above step, the microcomputer unit 13 calculates, as the correction coefficient, the inverse number of the change ratio A (a slope of line segment K in FIG. 2) of the measured β value to the recording power, using the currently measured β value and another measured β value (or the target β value if it is the first time) that is selected from among the past measured β values and is closest to the current measured p value. The microcomputer unit 13 also calculates the correction factor R_{UP} using formula (1) using the correction coefficient obtained above (SP9).

Subsequently, the microcomputer unit 13 associates the thus-obtained correction factor R_{UP} with the virtual zone 21 which was determined in the latest step SP3, and stores it in the correction factor management table 23 (SP10), and determines an area in the spare area for recording the data that was unsuccessfully recorded last time (SP11), and the processing then returns to step SP3. As a result, the data that was unsuccessfully recorded last time is recorded in the area in the spare area as determined in step SP11, using the target recording power corrected with the correction factor R_{UP} for the virtual zone 21 to which the above-mentioned area belongs (SP3 through SP12). After that, the microcomputer unit 13 changes the data recording destination back to the corresponding area in the user data area.

On the other hand, if step SP8 returns a negative judgment, the microcomputer unit 13 judges whether it has finished recording all the target data to be recorded on the optical disc 2 or not (SP12). If step SP12 returns a negative judgment, the microcomputer unit 13 returns to step SP3 and then repeats the same processing until step SP12 returns an affirmative judgment (SP3 through SP12 and then back to SP3).

If step SP12 returns an affirmative judgment when the microcomputer unit 13 has finished recording all the target data to be recorded on the optical disc 2, the microcomputer unit 13 terminates this recording processing.

On the other hand, if step SP1 returns a negative judgment, the microcomputer unit 13 starts recording data by means of, for example, the OPC by performing steps SP13 through SP16 in the same manner as steps SP2 through SP5.

Subsequently, the microcomputer unit 13 judges whether the user data area in which data is currently being recorded is a replaced area or not (SP17). This judgment is made in order to deal with the situation where the optical disc 2 is a re-writable type (RE); and if data is overwritten on the user data area where data has been already recorded, processing might have been executed to replace a defective site in the user data area, which was detected during the previous data recording, with some other area in the spare area.

If step SP17 returns an affirmative judgment, the microcomputer unit 13 returns to step SP14, reads the correction factor R_{UP} for the area in the spare area, to which data is to be recorded belongs, from the correction factor management table 23, corrects the target recording power using this correction factor R_{UP}, and then records the data in the relevant area. After that, the microcomputer unit 13 changes the data recording destination back to the corresponding area in the user data area.

If step SP17 returns a negative judgment, the microcomputer unit 13 judges whether or not a predetermined amount of time (or a predetermined interval) has passed since the start of data recording in step SP16 (SP18). If step SP18 returns a negative judgment, the processing returns to step SP17 and the processing for recording data on the optical disc 2 continues (from SP17 to SP18 and then back to SP17).

If step SP18 returns an affirmative judgment when a predetermined amount of time (or a predetermined interval) has passed since the start of recording data, the microcomputer unit 13 measures the β value in the same manner as in step SP7 (SP19).

Subsequently, the microcomputer unit 13 calculates the correction factor R_{UP} for the virtual zone 21 to which the area where the data has just been recorded belongs (SP20), associates the calculated correction factor R_{UP} with the relevant virtual zone 21 and stores them in the correction factor management table 23 (SP21), and then judges whether or not it has finished recording all the target data to be recorded on the optical disc 2 (SP22).

If step SP22 returns a negative judgment, the microcomputer unit 13 returns to step SP14 and then repeats the same processing until step SP22 returns an affirmative judgment (SP14 through SP22 and then back to SP14).

When step SP22 returns an affirmative judgment when recording all the target data to be recorded on the optical disc 2 is finished, the microcomputer unit 13 terminates this recording processing.

### (3) Effects of this Embodiment

With the optical disc device 1 according to this embodiment as described above, the recording area 20 (FIG. 3) of the optical disc 2 is divided into a plurality of virtual zones 21 and the correction factor R_{UP} is obtained and stored for each virtual zone 21; and when recording data on the optical disc 2, the APC control target recording power is corrected using the correction factor R_{UP} for the virtual zone 21 where that data is to be recorded. As a result, data can be always recorded with the optimum recording power, and the record quality of data recorded on the optical disc 2 can be ensured sufficiently for practical use.

### (4) Other Embodiments

The aforementioned embodiment describes the case where the present invention is utilized in the optical disc device 1 configured as illustrated in FIG. 1. However, the application of the present invention is not limited to the above-described example, and the invention can be utilized in a wide range of optical disc devices with various other configurations.

Also, the aforementioned embodiment describes the case where the reproduction unit for periodically reproducing data recorded on the optical disc 2 when recording data on the optical disc 2, is composed of the microcomputer unit 13, the digital signal processor 14, the optical pickup 16, and other components. However, the configuration of the reproduction unit is not limited to the above example, and a wide variety of other configurations can be used.

Furthermore, the aforementioned embodiment describes the case where the microcomputer unit 13 that controls the operation of the entire optical disc device 1 is configured to become: the correction factor calculator for obtaining the β value based on the waveform of the data reproduced from the optical disc 2 and then calculating the correction factor R_{UP} of the recording power based on the obtained β value; the correction factor management unit for dividing the recording area 20 of the optical disc 2 into a plurality of virtual zones 21 and managing the correction factor R_{UP} for each virtual zone 21; the recording power corrector for correcting the target recording power according to the correction factor R_{UP} for the virtual zone 21 where data is to be recorded next on the optical disc 2; and the verification unit for verifying whether data is recorded properly or not by comparing the data reproduced from the optical disc 2 with the target record data. However, part or all of the functions of the correction factor calculator, the correction factor management unit, the recording power corrector, and the verification unit may be assigned to the digital signal processor 14. Alternatively, a processor such as a CPU may be provided in addition to the microcomputer unit 13, and part or all of the functions of the correction factor calculator, the correction factor management unit, the recording power corrector, and the verification unit may be assigned to that processor.

The aforementioned embodiment also describes the case where the recording area 20 of the optical disc 2 is divided into, for example, five virtual zones 21. However, the number of virtual zones is not limited to the above example, and the recording area 20 may be divided into less than five virtual zones 21 or six or more virtual zones 21.

Moreover, the aforementioned embodiment describes the case where the present invention is utilized in an optical disc device 1 compatible with Blu-ray Discs. However, utilization of this invention is not limited to this example, and the invention may be utilized in a wide range of optical disc devices as long as they are compatible with optical discs having spare areas for any defects in data areas for recording data.

Furthermore, the aforementioned embodiment describes the case where the host computer 3 designates, by means of a recording command, which recording mode, either the verify mode or the walking OPC mode, should be employed by the optical disc device 1 when recording data. However, the invention is not limited to this example, and the optical disc device 1 may be configured so that its microcomputer unit 13 judges the type of the optical disc 2 (whether it is a Blu-ray Disc or a DVD) mounted in the optical disc device 1; and if the optical disc 2 is a Blu-ray Disc, data will be recorded in the verify mode; or if the optical disc 2 is a DVD, data will be recorded in the walking OPC mode.

While the invention has been described with respect to a limited number of embodiments, those skilled in the art, having benefit of this disclosure, will appreciate that other embodiments can be devised that do not depart from the scope of the invention as disclosed herein. Accordingly, the scope of the invention should be limited only by the attached claims.

What is claimed is:

1. An optical disc device comprising:
a reproduction unit for periodically reproducing data recorded on an optical disc when recording that data on the optical disc;
a correction factor calculator for obtaining a β value, an index of recording quality of the data on the optical disc, based on a waveform of the data reproduced by the reproduction unit, and calculating a correction factor of recording power based on the obtained β value;
a correction factor management unit for dividing a recording area of the optical disc into a plurality of zones and managing the correction factor for each of the zones; and
a recording power corrector for correcting the recording power according to the correction factor for the zone where data is to be recorded next on the optical disc.

2. The optical disc device according to claim 1, wherein the correction factor management unit manages a start address for each zone as well as the correction factor for each zone; and
the recording power corrector obtains the correction factor of the zone where the data is to be recorded, based on the start address of each zone.

3. The optical disc device according to claim 1, wherein the optical disc has a spare area for any defect in a data area for recording data, and
at least the correction factor management unit separates the data area and the spare area into different zones.

4. The optical disc device according to claim 3, wherein the optical disc is a Blu-ray Disc.

5. The optical disc device according to claim 1, further comprising a verification unit for verifying whether data is recorded properly or not by comparing the data reproduced from the optical disc with target record data,
wherein the correction factor calculator obtains the β value based on the waveform of the reproduced data obtained through the verification by the verification unit.

6. A recording power control method comprising:
a first step of periodically reproducing data recorded on an optical disc when recording that data on the optical disc;
a second step of obtaining a β value, an index of recording quality of the data on the optical disc, based on a waveform of the reproduced data, and calculating a correction factor of recording power based on the obtained β value; and
a third step of correcting the recording power according to the correction factor;
wherein a recording area of the optical disc is divided into a plurality of zones and the correction factor is managed for each of the zones; and
wherein in the third step, the recording power is corrected according to the correction factor for the zone where data is to be recorded next on the optical disc.

7. The recording power control method according to claim 6, wherein a start address for each zone is managed as well as the correction factor for each zone, and
wherein in the second step, the correction factor for the zone where the data is to be recorded is obtained based on the start address of each zone.

8. The recording power control method according to claim 6, wherein the optical disc has a spare area for any defect in a data area for recording data, and
at least the data area and the spare area are separated into different zones.

9. The recording power control method according to claim 8, wherein the optical disc is a Blu-ray Disc.

10. The recording power control method according to claim 6, wherein in the second step, whether data is recorded properly or not is verified by comparing the data reproduced from the optical disc with target record data, and the β value is obtained based on the waveform of the reproduced data obtained through the verification.
